(19) United States
(12) Patent Application Publication
(10) Pub. No.: US 2015/0063990 A1
(43) Pub. Date: Mar. 5, 2015

(54) Turbomachine Axial Compressor Seal with a Brush Seal

(71) Applicant: Techspace Aero S.A., Herstal (Milmort) (BE)

(72) Inventors: Arnaud Naert, Liege (BE); François Durieu, Havelange (BE)

(73) Assignee: Techspace Aero S.A., Herstal (Milmort) (BE)

(21) Appl. No.: 14/476,242

(22) Filed: Sep. 3, 2014

(30) Foreign Application Priority Data
Sep. 3, 2013 (EP) 13182815.4

(51) Int. Cl. F01D 11/00

(52) U.S. Cl. CPC F01D 11/001; F05D 2240/56
USPC 415/173.3

(57) ABSTRACT

The present application relates to an axial turbine engine compressor having a stator with an annular row of stator blades extending radially, an inner ferrule disposed at the inner ends of the stator blades, a downstream brush seal disposed on the inner ferrule which includes a profile of revolution extending substantially axially. The brush seal comprises bristles which extend mainly axially. The compressor also includes a rotor having an annular sealing surface, generally cylindrical or frusto-conical, disposed on the downstream side of the stator blades and which cooperates with the brush seal, so as to provide sealing between the internal ferrule and the rotor. The annular surface surrounds the brush seal, such that the pressure downstream of the brush seal tends to push said seal away from the annular surface. The brush seal wears less in contact with the annular surface.

This application claims priority under 35 U.S.C. §119 to European Patent Application No. 13182815.4, filed 3 Sep. 2013, titled “Turbomachine Axial Compressor Seal with a Brush Seal,” which is incorporated herein by reference for all purposes.

### BACKGROUND

1. Field of the Application

The present application relates to the field of rotatable sealing in a compressor of an axial turbomachine. More particularly, the present application relates to a brush seal of an axial turbomachine. More specifically, the present application relates to a brush seal between an inner ferrule and a rotor of an axial turbomachine compressor. The present application also relates to an axial turbomachine.

2. Description of Related Art

In order to increase the efficiency of a turbine engine, it is necessary to reduce leakage and recirculation of the working fluid. For this purpose, it is necessary to equip the turbine engine with annular seals between the rotor and the stator. A turbomachine can include several compressors, including a low-pressure compressor. In order to ensure a sealing in such a compressor, it is conceivable to use an annular brush seal.

This type of seal can help to provide a sealing between an inner ferrule of the rectifier and the rotor of the compressor. The brush seals include a plurality of bristles which can be oriented axially. The flexibility of the bristles is advantageous since it allows for radial and axial movements of the rotor relative to the stator, while maintaining sealing, and without degrading the brush seal.

Patent document published DE102005042272A1 discloses a compressor of an aircraft turbine engine comprising a rotor and a stator. The latter has a rectifier provided with an annular row of blades supporting an inner ferrule. The rotor comprises two annular rows of blades arranged upstream and downstream of the inner ferrule. The rotor comprises two annular platforms from which the rotor blades extend radially. The turbomachine comprises annular brush seals providing sealing between the inner ferrule of the rectifier and the platforms of the blades. These seals are arranged upstream and downstream of the inner ferrule and prevent the circulation of a flow between the inner ferrule and the rotor. However, the pressure differences tend to press the downstream seal against the rotor platform, and to wear it out quickly.

In addition, the presence of the downstream seal requires providing several steps on the inner surface of the fluid envelope. These downstream and upstream steps disrupt the flow, which impairs the efficiency of the compressor. This configuration adds an axial gap between the row of stator blades and the row of rotor blades disposed downstream.

Although great strides have been made in the area of compressor seals, many shortcomings remain.

### DESCRIPTION OF THE DRAWINGS

FIG. 1 shows an axial turbomachine according to the present application.

FIG. 2 is a representation of a turbomachine compressor according to a first embodiment of the present application.

FIG. 3 illustrates a portion of the compressor according to the first embodiment of the present application.

FIG. 4 a representation of a turbomachine compressor according to a second embodiment of the present application.

### DETAILED DESCRIPTION OF THE PREFERRED EMBODIMENT

The present application aims to solve at least one of the technical issues raised by the prior art. More precisely, the present application aims to increase the life of a brush seal arranged on an inner ferrule. The present application also aims to improve the compactness of a compressor with an attached brush seal whose bristles extend axially.

The present application is directed to a compressor of an axial turbomachine, comprising: a stator having an annular row of stator blades extending radially, an annular inner ferrule arranged at the inner ends of the stator blades, an annular brush seal disposed on the inner ferrule; a rotor having an annular sealing surface disposed on the downstream side of the row of stator blades and cooperating with the brush seal in order to provide sealing between the inner ferrule and the rotor, remarkable in that the annular surface surrounds the brush seal.

According to an advantageous embodiment of the present application, the brush seal comprises bristles extending generally axially and which are generally tangential to, or generally aligned with, the annular surface, the bristles preferably generally fitting closely with the internal envelope of the flow through the compressor. Some bristles can be generally tangential to, or generally aligned with, the annular surface since the latter can have a straight or curved revolution profile.

According to an advantageous embodiment of the present application, the annular surface is generally cylindrical, or generally frustoconical or the annular surface has a curved revolution profile which fits closely with the outer surface of the brush seal.

According to an advantageous embodiment of the present application, the brush seal is disposed axially at the downstream edge of the inner ferrule, the brush seal preferably extends axially from the edge of the inner ferrule.

According to an advantageous embodiment of the present application, the brush seal is integrated radially in the thickness of the inner ferrule, preferably the radial thickness of the profile of revolution of the brush seal is less than the average radial thickness the inner ferrule.

According to an advantageous embodiment of the present application, the rotor comprises an annular row of rotor blades disposed downstream of the stator blades and an annular platform disposed radially at the inner end of the rotor blades, the platform comprises an annular tubular sleeve whose inner surface forms the annular surface.

According to an advantageous embodiment of the present application, the annular surface is axially disposed away from the stator blades, the rotor blades preferably at least partially axially overlapping the brush seal.

According to an advantageous embodiment of the present application, the rotor comprises at least one radial annular groove for the radial retention of the rotor blades and which is open radially outwardly, the rotor blades comprise retention feet inserted in the radial groove so as to ensure radial retention of the rotor blades, the annular surface is arranged radially spaced from the radial groove.

According to an advantageous embodiment of the present application, the rotor blades comprise stops extending radially opposite the brush seal.

According to an advantageous embodiment of the present application, the rotor comprises an axially open annular groove forming the annular surface, and wherein the brush seal extends axially.

According to an advantageous embodiment of the present application, the brush seal extends in the axial majority of the axial groove and/or the brush seal radially occupies the majority of the axial groove.

According to an advantageous embodiment of the present application, the brush seal comprises an upstream portion inserted in the inner ferrule, and a free portion which projects with respect to the inner ferrule, the majority of the free portion of the brush seal extending in the axial groove.

According to an advantageous embodiment of the present application, the stator comprises two brush seals arranged upstream and downstream of the inner ferrule, said inner ferrule comprising an annular portion supporting the two annular brush seals, said portion preferably is made of the same material and integral.

According to an advantageous embodiment of the present application, the inner ferrule comprises a composite material, the composite material preferably forms the volume majority of the inner ferrule.

According to an advantageous embodiment of the present application, the rotor comprises a drum with a profile of revolution, the majority of the inner ferrule fitting closely with the external surface of the drum and/or the majority of the revolution profile of the inner surface of the inner ferrule is substantially parallel to the outer surface of the drum.

According to an advantageous embodiment of the present application, the profile of revolution of the annular surface is inclined by more than 1°, more preferably inclined by more than 10° relative to the axis of rotation of the compressor.

According to an advantageous embodiment of the present application, the annular surface is axially arranged within the rotor blades.

According to an advantageous embodiment of the present application, the bristles extend generally axially.

The present application is also directed to an axial turbomachine comprising a compressor, notably a low-pressure compressor, remarkable in that the compressor is according to the present application.

The present application ensures to avoid that the pressure difference between the upstream and downstream of the rectifier presses the brush seal against the annular surface of the rotor. Thus, the brush seal will be less subject to wear during operation of the compressor. Through this, the brush seal is preserved and its lifetime is extended.

The shape of the axial groove in which the brush seal is disposed can form a barrier to the flow of a possible leak. This form has baffles that slow down a possible leakage and improves the efficiency of the compressor.

The brush seal also allows to increase the compactness of the compressor. The thickness of the inner ferrule can be reduced. Similarly, the depth of the radial groove receiving the inner ferrule can be reduced, which helps to reduce the weight of the rotor. The radial proximity between the platform of the rotor blades and the junctions between the annular platforms promotes the robustness of the rotor, and allows reducing the thickness.

In the following description, the terms internal or interior and external or exterior refer to a position in relation to the axis of rotation of an axial turbomachine.

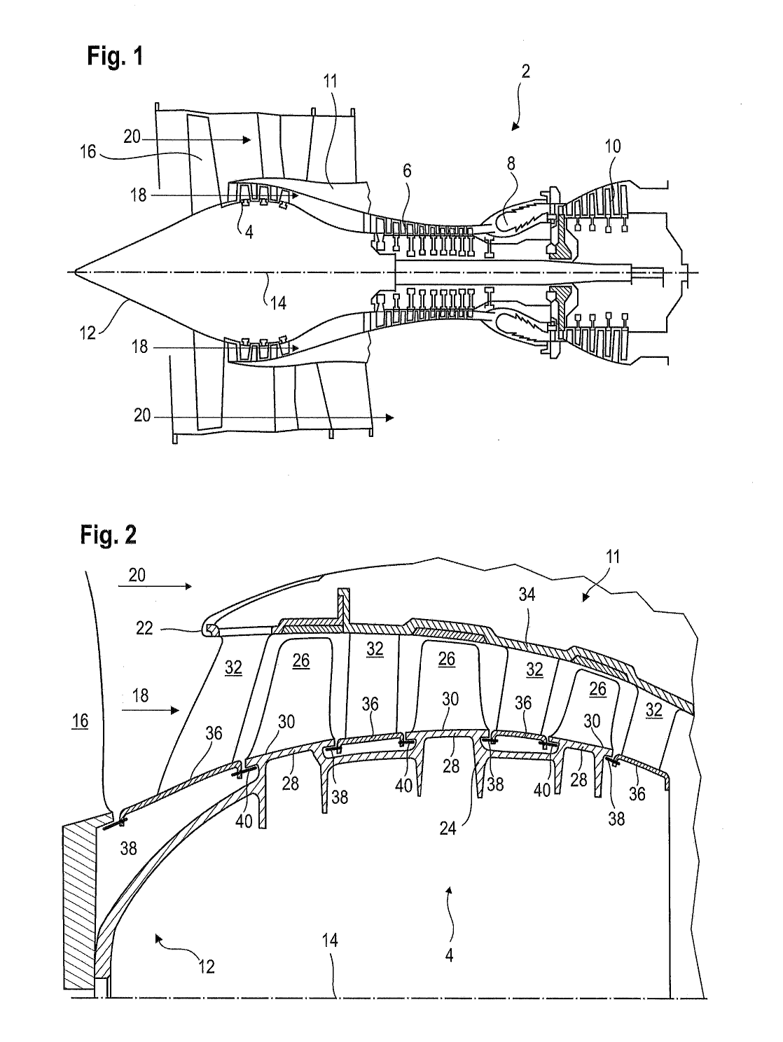

FIG. 1 schematically shows an axial turbomachine. It is in this case a double-flow turbojet. The turbojet 2 comprises a first compression level, designated low-pressure compressor 4, a second level of compression, designed high pressure compressor 6, a combustion chamber 8 and one or more levels of turbines 10. At least one compressor includes a stator and a rotor 12. Rotors can be coupled.

In operation, the mechanical power transmitted to the turbine 10 via the central shaft to the rotor 12 moves the two compressors 4 and 6. Means that increase the transmission ratio can increase the speed of rotation transmitted to the compressors. Alternatively, the various turbine stages can each be connected to compressor stages via concentric shafts. These compressor stages include several rows of rotor blades associated with rows of stator blades. Rotation of the rotor about its axis of rotation 14 generates a flow of air and gradually compresses the latter until the entry of the combustion chamber 10.

An intake fan 16 is coupled to the fan rotor 12 and generates an air flow which is divided into a primary flow 18 passing through the mentioned different above mentioned stages of the turbomachine, and a secondary flow 20 through an annular conduit (shown in part) along the machine that then joins the main flow at the turbine outlet. The primary flow 18 and secondary flow 20 are annular; they are channeled by the casing of the turbomachine. For this purpose, the casing has cylindrical walls or ferrules which can be internal and external.

FIG. 2 is a sectional view of an axial compressor of a turbomachine 2 as that of FIG. 1. The compressor can be a low-pressure compressor 4. One can observe a portion of the fan 16 and of the separation nose 22 that separates the primary flow stream 18 and the secondary flow stream 20.

The rotor 12 can include a substantially hollow drum 24. It shows, generally, a shape of revolution with a profile of revolution about the axis 14. Drum 24 can form an integral assembly optionally made of the same material. It can be made of a metal such titanium. The drum 24 can extend axially over the majority of the compressor 4. Profile of revolution of the drum 24 can be curved. According to the flow direction, it can form an increase in radius followed by a decrease in radius.

The rotor 12 comprises at least one, preferably a plurality of rows of rotor blades 26, in this case three. The rotor 12 can comprise at least one, preferably several annular platforms 28 which are each associated with a row of rotor blades 26. Annular platforms 28 can be mounting brackets from which the rotor blades 26 extend radially. The annular platforms 28 include outer surfaces 30 guiding the annular primary flow 18. The rotor blades 26 can be welded to the drum 24 so as to form an integral assembly.

The stator 11 comprises at least one rectifier, preferably several rectifiers, in this case four, which each contain a row of stator blades 32. Rectifiers are associated with the fan 16 or a row of rotor blades 26 for rectifying the airflow so as to convert the velocity pressure of the stream.

The stator blades 32 extend substantially radially from an outer casing 34 of the stator 11. The outer casing 34 can be made of a composite material. The stator blades 32 can be welded to the outer casing 34, or attached with an axle. The stator blades 32 are regularly spaced from each other, and have the same angular orientation in the stream. Advantageously, the blades of one row are identical. Optionally, the spacing between the blades can vary locally, as well as their angular orientation. Some blades can be different from the rest of their row of blades.

The stator 11 comprises at least one inner ferrule 36 associated with an annular row of stator blades, preferably several inner ferrule 36, each associated with an annular row of stator blades. Internal ferrules 36 generally have a form of revolution with a profile of revolution about the axis 14. Each revolution profile can have a form of “U” opened inwardly. The axial majority of the profile of revolution of at least one inner ferrule 36 is substantially parallel to the outer surface of the drum, which improves the compactness.

The inner ferrules 36 can comprise a composite material. At least one, preferably each inner ferrule 36 includes at least 10%, preferably at least 80% by volume of composite material. The inner ferrules 36 can be produced by injecting a resin into a mold. The resin can be a fiber-filled resin, and/or can comprise a mold preform.

An inner ferrule can comprise metal, e.g. titanium. It can be made by machining, forging, and/or bending.

The stator 11 comprises at least one, preferably several annular brush seals (38, 40) which cooperate with the rotor so as to provide sealing between the upstream and downstream of the associated rectifier. At least one or each brush seal (38, 40) can be configured to prevent fluid recirculation from downstream to upstream, which passes between an inner ferrule 36 and the drum 24. The stator can comprise brush seals (38, 40) which are arranged upstream and downstream of each inner ferrule 36 and which cooperate with the rotor 12 so as to provide sealing. At least one inner ferrule 36 includes an annular portion that supports an upstream brush seal 38 and a downstream brush seal 40. Said portion is preferably linked to the stator blades 26, and is optionally integrally formed of the same material. The portion can be made of composite materials.

At least one, preferably each brush seal (38, 40) is inserted in the thickness of the associated inner ferrule 36 for its fastening. Optionally, the radial thickness of the profile of revolution of one, preferably of each, brush seal is less than the average radial thickness of the profile of revolution of the associated inner ferrule. The brush seals (38, 40) can be embedded in the thickness of annular radial flanges of the inner ferrules.

According to one alternative of the present application, the rotor comprises brush seals, for example disposed on the annular platforms of the rotor, and which interact with the stator, optionally with inner ferrules, so as to provide sealing between each rectifier and the rotor.

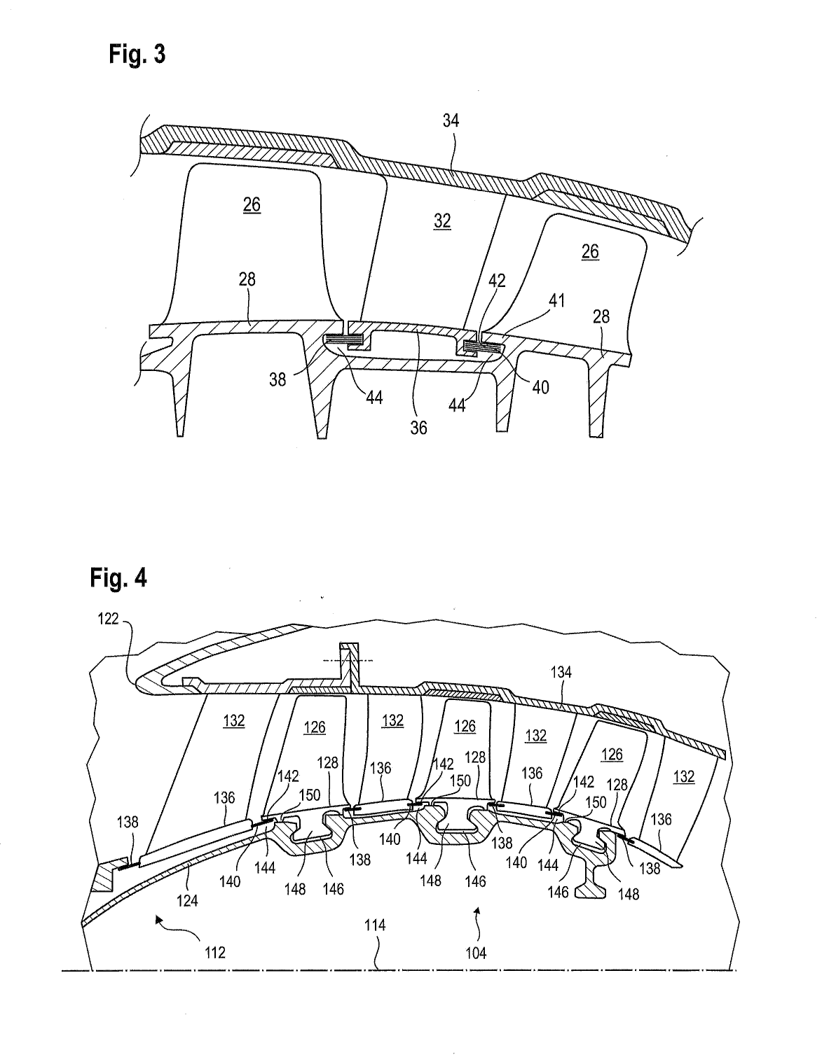

FIG. 3 outlines a portion of compressor according to the first embodiment of the present application.

At least one, preferably each brush seal (38, 40) comprises a portion inserted into the inner ferrule, and a free portion. The inserted portion can be an upstream portion; the free portion can be a downstream portion. Each free portion protrudes mainly axially with respect to the inner ferrule. Each inserted portion of the brush seal is attached to the corresponding inner ferrule 36.

At least one, preferably each brush seal (38, 40) comprises bristles which can extend mainly axially. The bristles are arranged at the upstream and downstream edges of the inner ferrule 36. Bristles are essentially flexible and have a given stiffness. They are able to deform elastically during the mounting of the compressor. The bristles can be made of polymer and have a diameter of less than 2 mm, preferably less than 0.10 mm.

The annular platform comprises a tubular sleeve 41 whose inner surface forms an annular sealing surface 42 which cooperates with a downstream brush seal 40 so as to provide sealing. The annular surface 42 surrounds an associated downstream brush seal 40. Preferably, the rotor includes annular surfaces 42 which are associated with each brush seal. Advantageously, the annular surfaces 42 are generally cylindrical, and possibly substantially conical or frustoconical. Each annular surface 42 can be substantially tangential to the outer surface of the associated brush seal. Possibly some bristles can be aligned with the annular surface. Each outer surface of the brush seal and/or each annular surface can generally match the inner envelope of the annular flow through the compressor.

The rotor can comprise at least one, preferably a plurality of axial annular grooves 44 that are axially open, for example towards an inner ferrule 36 disposed in vis-à-vis. Each axial groove 44 forms one of the annular surfaces 42, optionally an internal surface, which cooperates with a downstream brush seal 40. Each downstream brush seal 40 can be associated with an axial groove 44, and vice versa.

At least one, preferably each downstream brush seal 40 can extend in the axial majority of the associated axial groove 44, optionally at least one of the downstream brush seals 40 extends axially through the entire associated axial groove 44. At least one, preferably each profile of revolution of a downstream brush seal 40 can radially occupy the majority of the profile of the revolution of the associated axial groove. The thickness of the profile of revolution of at least one, preferably of each downstream brush seal 40 can be greater than the majority of the radial height of the profile of revolution of the associated groove.

The downstream seal brush 40 can be configured so that when the compressor is stopped, it exerts a pressure P1 against the associated annular surface 42, and when the compressor runs at a predetermined or nominal regime the downstream brush seal 40 exerts against the annular surface 42 a pressure P2 which is lower than the pressure P1. The pressure difference between P1 and. P2 is due to the increase of the pressure downstream of the stator blades 32 during operation of the compressor. The regime can be higher than 2 000 revolutions/minute, preferably greater than 4 000 revolutions/minute, more preferably greater than 8 000 revolutions/minute, optionally greater than 15 000 revolutions/minute. Pressure P2 can become zero when the compressor speed reaches its nominal speed. The bristles of the downstream brush seal 40 can be pre stressed and exert a force against the annular surface when mounted in the compressor, the latter being stationary. In operation, the pressure difference has for effect to push away the bristles, those disposed outside touching the annular surface 42.

FIG. 4 outlines a compressor 104 according to a second embodiment of the present application. FIG. 4 uses the numbering of the preceding figures for the same or similar elements, however, the numbering being incremented by 100. Specific numbers are used for specific items in this embodiment.

The rotor 112 can include a drum 124 made in one piece with at least one, preferably a plurality of annular radial grooves 146 that are open radially and outwardly. Each radial groove 146 can be associated with an annular row of rotor blades 126. The radial grooves 146 include sloped walls which can flare outwardly.

The rotor blades 126 can include platforms 128 and retention feet 148, for example shaped as dovetail and inserted into the radial grooves 146. The grooves and feet can be configured to allow an inward radial retention of the rotor blades 126. The retention feet extend radially from their associated platforms 128 towards the bottom of the radial groove 146 that houses said feet. The assembly of the platforms of the blades can form an annular surface 142 that cooperates with a brush seal (138, 140). Each profile of revolution of a brush seal is radially away from the nearest annular groove.

The axial grooves 144 are delimited by the platforms 128 and the drum 124. The rotor blades 126 can include stops 150 configured to limit, possibly to prevent, their tilt from upstream to downstream. The stops 150 extend radially from their associated platforms 128, and cooperate with the drum 124, for example on either side of the grooves 146, axially and/or radially. The stops 150 can extend radially at the level of the brush seals. At least one stop can extend radially on the majority of the associated axial groove 144.

At least one of, preferably each inner ferrule 136 can generally have a constant thickness, in which the brush seals 136 are housed. The inner surface of each inner ferrule 136 can conform to the external surface of the drum 124.

It should be noted that each of the two specific embodiments specifications can be applied to another embodiment or any other embodiment in accordance with the claims.

We claim:

1. A compressor of an axial turbomachine, comprising:
a stator comprising:
an annular row of stator blades extending radially;
an inner ferrule disposed at the inner ends of the stator blades; and
a brush seal disposed on the inner ferrule; and
a rotor having an annular sealing surface disposed on the downstream side of the row of stator blades and which cooperates with the brush seal, so as to provide a sealing between the inner ferrule and the rotor;
wherein the annular surface surrounds the brush seal.

2. The compressor according to claim 1, wherein the brush seal comprises:
bristles extending generally axially and which are tangential to, or generally aligned with, the annular surface, such that the bristles generally fit closely with the inner envelope of the flow through the compressor.

3. The compressor according to claim 1, wherein the annular surface is generally cylindrical, or generally frustoconical, or the annular surface has a curved profile of revolution which fits closely with the outer surface of the brush seal.

4. The compressor according to claim 1, wherein the brush seal is disposed axially at the downstream edge of the inner ferrule, in that the brush seal extends axially from the edge of the inner ferrule.

5. The compressor according to claim 1, wherein the brush seal is radially integrated in the thickness of the inner ferrule, in that the radial thickness of the profile of revolution of the brush seal is less than the average radial thickness of the inner ferrule.

6. The compressor according to claim 1, wherein the rotor comprises:
an annular row of rotor blades disposed downstream of the stator blades; and
an annular platform disposed radially at the inner end of the rotor blades, the annular platform comprising:
a tubular sleeve whose inner surface forms the surface ring.

7. The compressor according to claim 1, wherein the annular surface is disposed axially away from the stator blades, in that the rotor blades at least partially axially overlap the brush seal.

8. The compressor according to claim 6, wherein the rotor comprises:
at least one radial annular groove of radial retention of the rotor blades which is open radially outwardly, the rotor blades comprising:
retention feet inserted in the radial groove, so as to ensure radial retention of the rotor blades, the annular surface being disposed radially away from the radial groove.

9. The compressor according to claim 6, wherein the rotor blades comprise:
stops extending radially opposite the brush seal.

10. The compressor according to claim 1, wherein the rotor comprises:
an axial annular groove that opens axially and which forms the annular surface;
wherein the brush seal extends axially.

11. The compressor according to claim 10, wherein the brush seal extends in the axial majority of the axial groove and the seal brush radially occupies the majority of the axial groove.

12. The compressor according to claim 10, wherein the brush seal extends in the axial majority of the axial groove or the seal brush radially occupies the majority of the axial groove.

13. The compressor according to claim 10, wherein the brush seal comprises:
an upstream portion inserted in the inner ferrule; and
a free downstream portion projecting relative to the inner ferrule, the majority of the free portion of the brush seal extending in the axial groove.

14. The compressor according to claim 1, wherein the stator comprises:
two brush seals arranged upstream and downstream of the inner ferrule, the inner ferrule comprising:
an annular portion supporting the two brush seals, the annular portion being formed integrally.

15. The compressor according to claim 1, wherein the inner ferrule comprises:
a composite material that forms the volume majority of the inner ferrule.

16. An axial turbomachine, comprising:
a low pressure compressor comprising:
a stator comprising:
an annular row of stator blades extending radially;
an inner ferrule disposed at the inner ends of the stator blades; and
a brush seal disposed on the inner ferrule; and
a rotor having an annular sealing surface disposed on the downstream side of the row of stator blades and which cooperates with the brush seal, so as to provide a sealing between the inner ferrule and the rotor;
wherein the annular surface surrounds the brush seal;
a high pressure compressor;
a combustion chamber; and
one or more levels of turbines.
